(19) United States
(12) Patent Application Publication
(10) Pub. No.: US 2021/0353983 A1
(43) Pub. Date: Nov. 18, 2021

(54) Fire Suppression Assembly

(71) Applicant: Jennie Karagatzides, Toronto (CA)

(72) Inventor: Jennie Karagatzides, Toronto (CA)

(21) Appl. No.: 15/931,245

(22) Filed: May 13, 2020

(51) Int. Cl. A62C 2/04; A62C 3/00

(52) U.S. Cl. CPC A62C 2/04; A62C 3/006

(57) ABSTRACT

A fire suppression assembly includes a dome that is positionable over a stove top or a cooking pot in which a fire has started. The dome is comprised of a fluid impermeable material to inhibit oxygen from feeding the fire thereby facilitating the fire to extinguish. A receiver is coupled to and extends away from the dome. A handle is pivotally coupled to the receiver to be gripped for placing the dome over the stove top or the cooking pot. The handle is positionable in a first position has the handle extending upwardly from the receiver. Conversely, the handle is positionable in a second position has the handle extending laterally away from the receiver.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to suppression devices and more particularly pertains to a new suppression device for extinguishing a fire on a stove top or in a cooking pot.

### (2) Description of Related Art including information disclosed under 37 CFR 1.97 and 1.98

The prior art relates to suppression devices. The prior art discloses a fire lid that is positionable on a stove top or on a cooking pot which has a handle extending laterally away therefrom to keep a user's hands away from the fire. The prior art discloses a fire lid that has a cup shape and which is positionable over a cooking pot for extinguishing a fire in the cooking pot. The prior art also discloses a fire mat that has a handle extending laterally therefrom and the fire mat is positionable on a cooking pot to extinguish a fire in the cooking pot. The prior art discloses an inflatable bag that drops from a fire hood over a fire in a cooking pot for extinguishing the fire. Additionally, the prior art discloses a fire dome, comprising a plurality of pivotable sections, that can be positioned over an open flame for extinguishing the open flame.

### BRIEF SUMMARY OF THE INVENTION

An embodiment of the disclosure meets the needs presented above by generally comprising a dome that is positionable over a stove top or a cooking pot in which a fire has started. The dome is comprised of a fluid impermeable material to inhibit oxygen from feeding the fire thereby facilitating the fire to extinguish. A receiver is coupled to and extends away from the dome. A handle is pivotally coupled to the receiver to be gripped for placing the dome over the stove top or cooking pot. The handle is positionable in a first position has the handle extending upwardly from the receiver. Conversely, the handle is positionable in a second position has the handle extending laterally away from the receiver.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top perspective view of a fire suppression assembly according to an embodiment of the disclosure.

FIG. 2 is a front view of an embodiment of the disclosure.

FIG. 3 is a bottom phantom view of an embodiment of the disclosure.

FIG. 4 is a perspective in-use view of an embodiment of the disclosure being placed over a cooking pot.

FIG. 5 is a perspective in-use view of an embodiment of the disclosure being placed over a cooking element on a stove top.

### DETAILED DESCRIPTION OF THE INVENTION

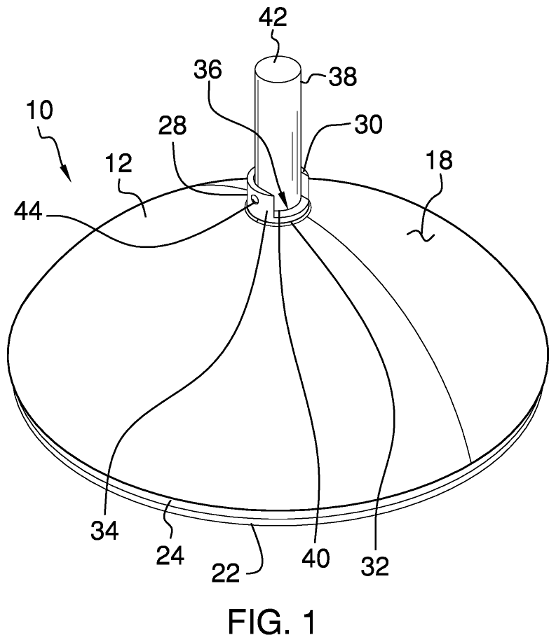

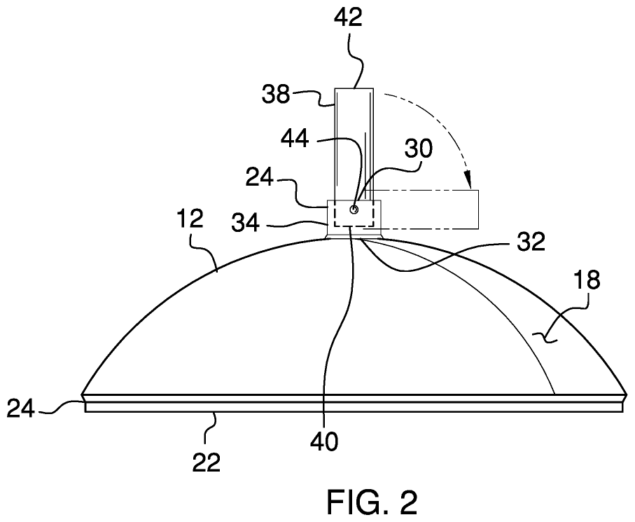

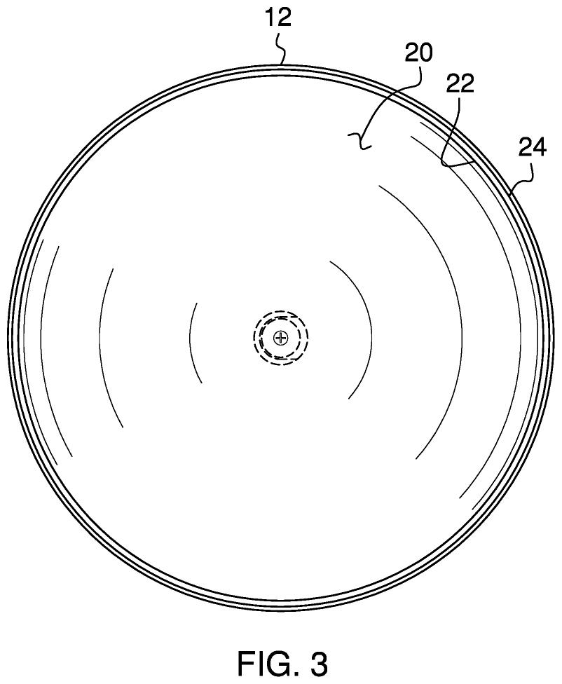

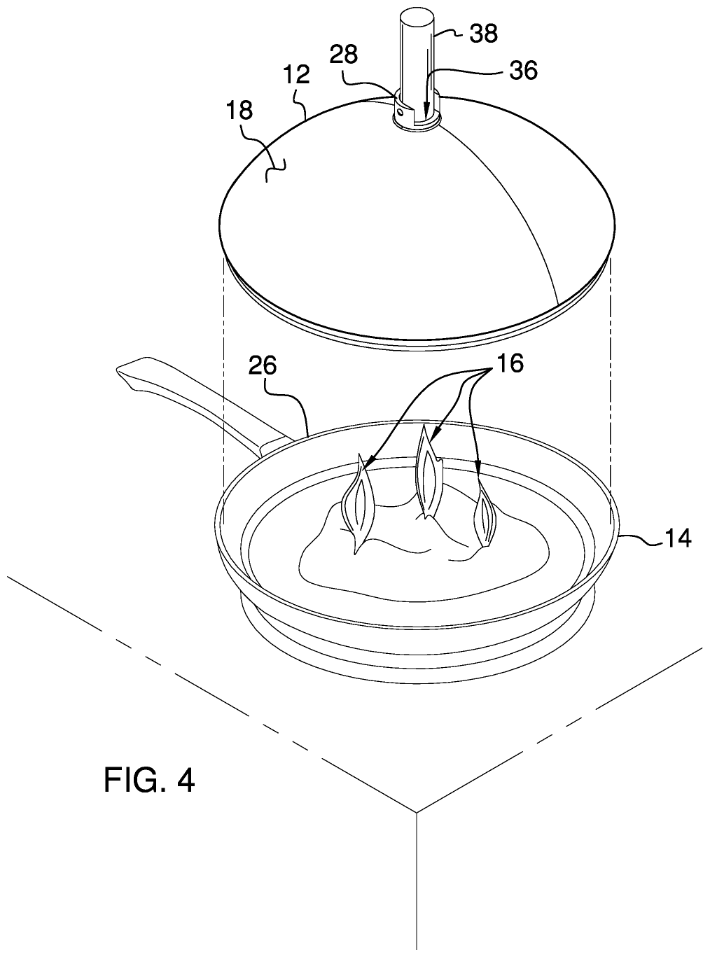

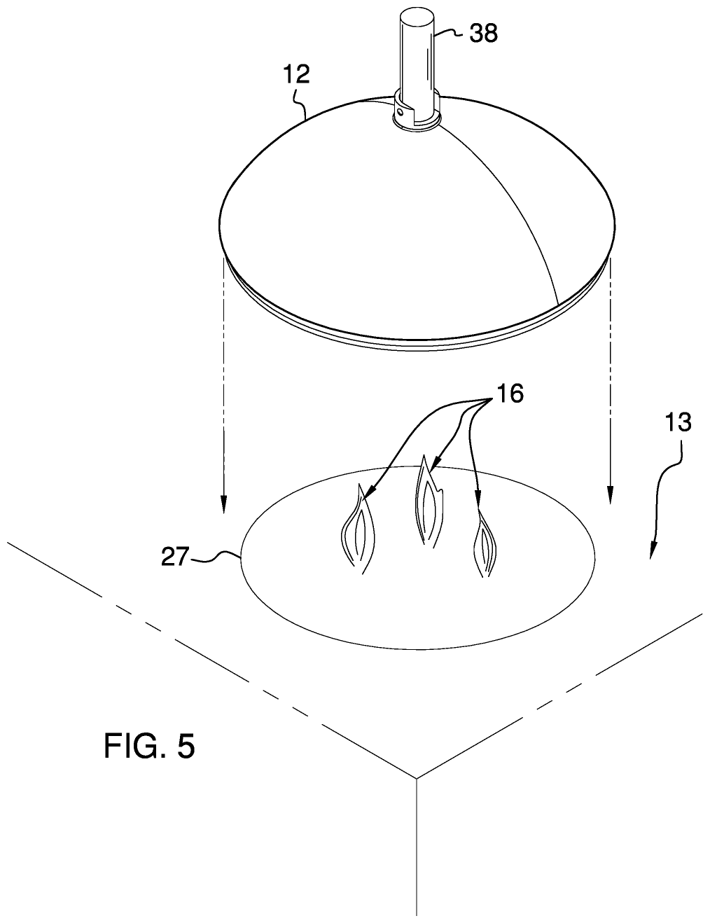

With reference now to the drawings, and in particular to FIGS. 1 through 5 thereof, a new suppression device embodying the principles and concepts of an embodiment of the disclosure and generally designated by the reference numeral 10 will be described.

As best illustrated in FIGS. 1 through 5, the fire suppression assembly 10 generally comprises a dome 12 that is positionable over a stove top 13 or a cooking pot 14 in which a fire 16 has started. The stove top 13 may have electrical cooking elements, gas burners or any other type of heat source commonly used for cooking in a kitchen. The cooking pot 14 may be a frying pan, a dutch oven, a sauce pan or any other type of cylindrical cooking pot. The dome 12 is comprised of a fluid impermeable material to inhibit oxygen from feeding the fire 16 thereby facilitating the fire 16 to extinguish.

Moreover, the dome 12 is comprised of a heat resistant material to resist being damaged by the fire 16.

The dome 12 has a top surface 18, a bottom surface 20 and a lower edge 22, and each of the top surface 18 and the bottom surface 20 is concavely arcuate with respect to the lower edge 22. The top surface 18 has a depression 24 extending toward the bottom surface 20 and the depression 24 is aligned with the lower edge 22. The depression 24 extends around a full circumference of the dome 12 to accommodate a top edge 26 of the cooking pot 14 when the dome 12 is positioned on the cooking pot 14. The dome 12 is produced in a variety of circumferences for accommodating the circumference of the cooking pot 14 or the circumference of a heating element 27 on the stove top 13.

A receiver 28 is provided and the receiver 28 is coupled to and extends away from the dome 12. The receiver 28 has a bottom end 30, a top end 32 and an outer wall 34 extending therebetween. The outer wall 34 is continuously arcuate about a center line of the receiver 28 such that the receiver 28 has a cylindrical shape. The outer wall 34 has a notch 36 therein and the notch 36 extends from the top end 32 toward the bottom end 30. Additionally, the notch 36 partially extends around a circumference of the outer wall 34. Additionally, the top end 32 of the receiver 28 is open.

A handle 38 is pivotally coupled to the receiver 28 to be gripped for placing the dome 12 over the cooking pot 14. The handle 38 is positionable in a first position having the handle 38 extending upwardly from the receiver 28. The handle 38 is positionable in a second position having the handle 38 extending laterally away from the receiver 28. The handle 38 has a lower end 40 and an upper end 42, and the lower end 40 is positioned in the receiver 28.

The handle 38 extends upwardly from the top end 32 of the receiver 28 when the handle 38 is positioned in the first position. Conversely, the handle 38 extends through the notch 36 in the outer wall 34 of the receiver 28 when the handle 38 is positioned in the second position. A pin 44 extends through the outer wall 34 of the receiver 28 and extends through the handle 38 for pivotally retaining the handle 38 on the receiver 28.

In use, the handle 38 is gripped and the dome 12 is positioned over the cooking pot 14 or the heating element 27 on the stove top 13 when a fire 16 starts in the cooking pot 14 or on the stove top 13. In this way the dome 12 extinguishes the fire 16 by starving the fire 16 of oxygen. The handle 38 pivots between the first position and the second position, depending on the angle of the user's wrist with respect to the dome 12, for enhancing ergonomic comfort for the user. The dome 12 can be stored in a location that is near to a stove in a kitchen or the like to ensure that the dome 12 is quickly accessible in the event of a fire 16 in the cooking pot 14 or the stove top 13.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A fire suppression assembly being positionable on a stove top or a cooking pot in which a fire has started for suppressing the fire, said assembly comprising:
a dome being positionable over a stove top or a cooking pot in which a fire has started, said dome being comprised of a fluid impermeable material wherein said dome is configured to inhibit oxygen from feeding the fire thereby facilitating the fire to extinguish, said dome being comprised of a heat resistant material wherein said dome is configured to resist being damaged by the fire;
a receiver being coupled to and extending away from said dome; and
a handle being pivotally coupled to said receiver wherein said handle is configured to be gripped for placing said dome over the stove top or the cooking pot, said handle being positionable in a first position having said handle extending upwardly from said receiver, said handle being positionable in a second position having said handle extending laterally away from said receiver.

2. The assembly according to claim 1, wherein said dome has a top surface, a bottom surface and a lower edge, each of said top surface and said bottom surface being concavely arcuate with respect to said lower edge, said top surface having a depression extending toward said bottom surface, said depression being aligned with said lower edge, said depression extending around a fill circumference of said dome wherein said depression is configured to accommodate a top edge of the cooking pot when said dome is positioned on the cooking pot.

3. The assembly according to claim 2, wherein said receiver has a bottom end, a top end and an outer wall extending therebetween, said outer wall being continuously arcuate about a center line of said receiver such that said receiver has a cylindrical shape.

4. The assembly according to claim 3, wherein said outer wall has a notch therein, said notch extending from said top end toward said bottom end, said notch partially extending around a circumference of said outer wall.

5. The assembly according to claim 3, wherein said handle has a lower end and an upper end, said lower end being positioned in said receiver, said handle extending upwardly from said top end of said receiver when said handle is positioned in said first position.

6. The assembly according to claim 4, wherein said handle extends through said notch in said outer wall of said receiver when said handle is positioned in said second position.

7. The assembly according to claim 3, further comprising a pin extending through said outer wall of said receiver and extending through said handle for pivotally retaining said handle on said receiver.

8. A fire suppression assembly being positionable on a stove top or a cooking pot in which a fire has started for suppressing the fire, said assembly comprising:
a dome being positionable over a stove top or a cooking pot in which a fire has started, said dome being comprised of a fluid impermeable material wherein said dome is configured to inhibit oxygen from feeding the fire thereby facilitating the fire to extinguish, said dome being comprised of a heat resistant material wherein said dome is configured to resist being damaged by the fire, said dome having a top surface, a bottom surface and a lower edge, each of said top surface and said bottom surface being concavely arcuate with respect to said lower edge, said top surface having a depression extending toward said bottom surface, said depression being aligned with said lower edge, said depression extending around a fill circumference of said dome wherein said depression is configured to accommodate a top edge of the cooking pot when said dome is positioned on the cooking pot;
a receiver being coupled to and extending away from said dome, said receiver having a bottom end, a top end and an outer wall extending therebetween, said outer wall being continuously arcuate about a center line of said receiver such that said receiver has a cylindrical shape, said outer wall having a notch therein, said notch extending from said top end toward said bottom end, said notch partially extending around a circumference of said outer wall;
a handle being pivotally coupled to said receiver wherein said handle is configured to be gripped for placing said dome over the stove top or the cooking pot, said handle being positionable in a first position having said handle extending upwardly from said receiver, said handle being positionable in a second position having said handle extending laterally away from said receiver, said handle having a lower end and an upper end, said lower end being positioned in said receiver, said handle extending upwardly from said top end of said receiver when said handle is positioned in said first position, said handle extending through said notch in said outer wall of said receiver when said handle is positioned in said second position; and
a pin extending through said outer wall of said receiver and extending through said handle for pivotally retaining said handle on said receiver.
